(19) United States
(12) Patent Application Publication
(10) Pub. No.: US 2026/0328478 A1
(43) Pub. Date: Oct. 22, 2026

(54) ULTRAFAST HIGH-TEMPERATURE SINTERING APPARATUS

(71) Applicant: Belenos Clean Power Holding AG, Biel/Bienne (CH)

(72) Inventors: Reto PFENNINGER, Wangen bei Olten (CH); Kostiantyn KRAVCHYK, Zürich (CH); Romain DUBEY, Dübendorf (CH); Maksym KOVALENKO, Zürich (CH); Daniele PEREGO, Baden (CH); Werner SCHEIFELE, Rheinfelden (CH); Olivia DE LOS COBOS, Beaucourt (CH)

(73) Assignee: Belenos Clean Power Holding AG, Biel/Bienne (CH)

(21) Appl. No.: 19/115,570

(22) PCT Filed: Oct. 2, 2023
(86) PCT No.: PCT/EP2023/077278

§ 371 Date: Mar. 26, 2025

(30) Foreign Application Priority Data
Oct. 6, 2022 (EP) 22200017.6

(51) Int. Cl. F27D 11/04; C22B 1/16; F27D 21/00; F27D 21/02

(52) U.S. Cl. CPC F27D 11/04; C22B 1/16; F27D 21/0014; F27D 21/02

(57) ABSTRACT

An ultrafast high-temperature sintering apparatus comprising a first and a second carbon-comprising thermally conductive substrate arranged at a distance from each other, thereby providing a space for receiving a substrate to be sintered, and provided between a third and a fourth thermally conductive substrate; and a heating for heating the third and/or the fourth thermally conductive substrate, thereby heating the first and/or the second thermally conductive substrate, respectively, wherein the third and the fourth thermally conductive substrate include, independently from one another, one or more metal nitride and/or metal oxide.

### TECHNICAL FIELD OF THE INVENTION

The present invention relates to a sintering apparatus, in particular to an ultrafast high-temperature sintering apparatus.

### BACKGROUND

Traditional sintering methods typically take place in so-called bulk furnaces, where they are heated to the required sintering temperatures, which depend on the material composition to be sintered. Disadvantages of such bulk furnaces include long heating and cooling down times (i.e. a low heating rate and a low cooling rate), difficult control of the temperature and the heat distribution (i.e. the uniformity of the temperature), a high energy consumption (due to the long heating times), and increased total processing time. This leads to non-uniform sintering, and thus a limited sintering quality. This also leads to a lower throughput (lower number of sintered objects produced in a certain period of time), making these sintering techniques less suitable for application at industrial scale.

More recently, new sintering methods and improved sintering apparatuses have been developed, including micro-wave assisted sintering, spark plasma sintering, and flash sintering. However, microwave-assisted sintering largely depends on the microwave absorption properties of the material to be sintered, which limits the applicability thereof. Spark plasma sintering apparatuses require dies to compress the material during sintering, which limits the geometry of the component to be sintered, as well as the scalability. Further, it is not suitable for sintering complex three-dimensional structures due to the applied pressure. Flash-sintering apparatuses are capable to heat at a heating rate of up to 10000 °C/min, but require expensive platina electrodes. Flash-sintering apparatuses are also less suited for sintering components having a complex geometry, such as three-dimensional structures.

CN208567515 discloses a sintering apparatus comprising from the inside to the outside a furnace body comprising graphite heating body, an electrical insulating layer, which is a heat insulating high temperature resistant rock wool, and a thermally insulating layer comprising first a hard graphite felt and then an aluminium silicate fibre layer.

US2007/0202455 discloses a firing apparatus comprising a muffle having at two parallel sides a heater or heat generator. The muffle and heater or heat generator are enclosed by a plurality of heat insulating layers made of carbon. The heaters can be made of graphite or can be a carbon member. Another embodiment discloses a carbon member acting as both muffle and heater.

Another recently developed sintering apparatus is an ultrafast high-temperature sintering apparatus.

WO2020/236767 discloses a fast high-temperature sintering system and method. A substrate to be sintered is placed between two thermally conductive carbon elements with a distance of 0 to 10 mm between each thermally conductive carbon element and the substrate. The thermally conductive carbon elements are heated by an electrical current to a temperature between 500 °C and 3000 °C, and sintering is performed within 1 second to 1 hour by heating the substrate with the heated thermally conductive carbon elements.

A disadvantage of the foregoing ultrafast high-temperature sintering apparatuses is that self-standing substrates, i.e. without a support or carrier being present, are difficult to sinter. Especially in the case of flat self-standing substrates, it is difficult with the foregoing apparatuses to maintain the flatness of the substrate during sintering. In other words, sintered substrates obtained by means of the foregoing apparatuses, when sintered without a carrier or support present, tend to be bent, show curves, and even may show cracks, or may start to crack when trying to flatten the sintered substrate post-sintering.

### SUMMARY OF THE INVENTION

The present invention aims to overcome one or more of the above drawbacks. It is an aim of the invention to provide a sintering apparatus allowing reduced sintering times and/or improved control of the sintering conditions, in particular the sintering temperature. It is a further aim to provide a sintering apparatus allowing a more uniform sintering. It is a further aim to provide a sintering apparatus that is capable to sinter thin, i.e. having a thickness below 100 μm, and/or flat substrates, without imparting damage or deformation to the sintered substrates, i.e. thereby maintaining the flatness. It is a further aim to provide a sintering apparatus having a reduced energy consumption.

The term “substrate” as part of the sintering apparatus is used in the present disclosure for components or layers of the sintering apparatus, in particular layers having a sheet-like shape.

Advantageously, the sintering apparatus is an ultrafast high-temperature sintering apparatus. The term “ultrafast sintering” is used in the present disclosure for sintering apparatuses that are capable of being heated at a heating rate of at least 50 °C/s, and optionally being cooled at a cooling rate of at least 50 °C/s. The term “high-temperature sintering apparatus” is used in the present disclosure for sintering apparatuses that can be heated to temperatures of at least 750 °C, preferably at least 900 °C, such as between 750 °C and 1400 °C, more preferably between 900 °C and 1250 °C.

According to an aspect of the invention, there is disclosed a sintering apparatus according to the appended claims.

A sintering apparatus according to the present disclosure comprises a first thermally conductive substrate and a second thermally conductive substrate arranged at a distance from each other, thereby providing a space for receiving a substrate, i.e. an article or an object, to be sintered.

The first and the second thermally conductive substrate are provided between a third thermally conductive substrate and a fourth thermally conductive substrate. In other words, the third and the fourth thermally conductive substrate are provided at the outer surface of the first and the second thermally conductive substrate, respectively.

The first and the second thermally conductive substrate comprise carbon.

The third thermally conductive substrate and the fourth thermally conductive substrate comprise, independently from one another, one or more metal nitride and/or metal oxide. Advantageously, the third and the fourth thermally conductive substrates comprise, independently from one another, one or more monocrystalline metal nitride and/or monocrystalline metal oxide.

Advantageously, the (monocrystalline) metal nitride comprises (monocrystalline) boron nitride and/or (monocrystalline) aluminium nitride. Advantageously, the (monocrystalline) metal oxide comprises (monocrystalline) alumina and/or (monocrystalline) sapphire, such as sapphire single crystals.

Advantageously, the first thermally conductive substrate contacts at least partially the third thermally conductive substrate. Alternatively or additionally, and advantageously, the second thermally conductive substrate contacts at least partially the fourth thermally conductive substrate. With “contacting at least partially” is meant in the present invention that the two substrates make contact, i.e. contact each other, over at least a portion of the respective surfaces of the substrates facing each other.

The sintering apparatus further comprises heating means. The heating means are arranged or provided, in use of the apparatus, for heating the third thermally conductive substrate and/or the fourth thermally conductive substrate. The heating means are provided so that, in use, they can heat the third and/or the fourth thermally conductive substrate at a heating rate of at least 50 °C/s. The heating means are provided so that, in use, they can heat the third and/or the fourth thermally conductive substrate to a temperature between 750 °C and 1400 °C, preferably between 900 °C and 1250 °C. The heating means are arranged so that, in use, upon heating the third and/or the fourth thermally conductive substrate, the first and/or the second thermally conductive substrate, respectively, are heated.

Advantageously, the sintering apparatus further comprises a first conductor at an outer surface of the third thermally conductive substrate. Alternatively or additionally, and advantageously, the sintering apparatus further comprises a second conductor at an outer surface of the fourth thermally conductive substrate.

Advantageously, when a first and a second conductor are provided, the first and the second conductor together at least partially, and preferably entirely, enclose the first, the second, the third and the fourth thermally conductive substrate, and the space (i.e. the space between the first and the second thermally conductive substrate).

Advantageously, the first and the second conductor comprise carbon. Examples of carbon-comprising conductors include, without being limited thereto, graphite, carbon fibres, carbon nanotubes, or combinations of two or more thereof. The first and the second conductor can have the same or a different composition.

Advantageously, the sintering apparatus further comprises a first supporting means provided at an outer surface of the first conductor. Alternatively or additionally, and advantageously, the sintering apparatus further comprises a second supporting means provided at an outer surface of the second conductor. Advantageously, each one of the first supporting means and the second supporting means, when provided, independently comprises a thermally and electronically insulating ceramic substrate and at least one metallic supporting component. Advantageously, the supporting means is arranged so that the metallic supporting component contacts the thermally and electronically insulating ceramic substrate and the conductor. In other words, when a first, respectively second, supporting means is provided, it is arranged so that the metallic supporting component thereof contacts the thermally and electronically insulating ceramic substrate thereof and the surface of the first, respectively second, conductor facing the supporting means (i.e. the outer surface of the respective conductor). Advantageously, the supporting means is arranged so that the metallic supporting component(s) and the thermally and electronically insulating ceramic substrate mechanically support the conductor.

Advantageously, the thermally and electronically insulating ceramic substrate comprises alumina (i.e. aluminium oxide).

Advantageously, the metallic supporting component comprises tungsten or an alloy thereof. Non-limiting examples of tungsten comprising alloys are tungsten nickel iron alloys, tungsten nickel copper alloys and tungsten carbide alloys.

Advantageously, when the sintering apparatus comprises a first conductor and/or a second conductor, the heating means comprise means for inducing an electrical current to the first conductor and/or the second conductor. Advantageously, in use when an electrical current is induced to the first and/or the second conductor, the third and/or the fourth thermally conductive substrate are heated, advantageously by means of Joule heating. Joule heating is also known as resistive heating or Ohmic heating. Advantageously, upon inducing an electrical current (in use of the apparatus) to the first and/or the second conductor, any Ohmic losses or resistive losses in the first and/or the second conductor dissipates in the form of heat, which heats the third and/or the fourth thermally conductive substrate.

Advantageously, the sintering apparatus further comprises, in addition to the first and/or the second conductor, a third conductor and a fourth conductor. Advantageously, the third conductor is provided at a proximal end of the first conductor and/or at a proximal end of the second conductor. Advantageously, the fourth conductor is provided at a distal end of the first conductor and/or at a distal end of the second conductor.

For example, when the sintering apparatus comprises only a first (or second) conductor, the third conductor is provided at a proximal end of the first (or second) conductor, and the fourth conductor is provided at a distal end of the first (or second conductor). For example, when the sintering apparatus comprises a first and a second conductor, the third conductor is provided at a proximal end of the first conductor and at a proximal end of the second conductor, and the fourth conductor is provided at a distal end of the first conductor and at a distal end of the second conductor.

Advantageously, when the sintering apparatus comprises a third and a fourth conductor, provided as explained hereinbefore, the heating means comprise means for inducing an electrical current to the third and the fourth conductor. Advantageously, in use when an electrical current is induced to the third and the fourth conductor, the electrical current is induced to the first and/or the second conductor, and the third and/or the fourth thermally conductive substrate are heated.

Advantageously, the third and the fourth conductor comprise, independently, copper, copper alloys, silver, silver alloys, tungsten, tungsten alloys, or combinations of two or more thereof.

Alternatively or additionally to the heating means comprising means for inducing an electrical current, and advantageously, the heating means comprises an infrared (IR) light source.

Advantageously, when the heating means comprises an IR light source, the sintering apparatus further comprises one or more lenses. Advantageously, the lenses are arranged to allow, in use, focussing of the IR light beam towards the third and/or the fourth conductive substrate.

The heating means can be arranged to allow heating the third and the fourth thermally conductive substrate independently of one another. For example, the heating means can be arranged to, in use, heat the third and the fourth thermally conductive substrates according to the same heating profile, such as at the same heating rate and/or to the same temperature. Alternatively, the heating means can be arranged to, in use, heat the third and the fourth thermally conductive substrate to, for example, another temperature and/or at a different heating rate.

Advantageously, the sintering apparatus further comprises means for monitoring the temperature. Advantageously, the sintering apparatus further comprises means for monitoring the temperature of the space between the first and the second thermally conductive substrate. Alternatively or additionally, and advantageously, the sintering apparatus further comprises means for monitoring the temperature of the third and/or the fourth thermally conductive substrate. Advantageously, the means for controlling the temperature comprises an infrared (IR) camera.

An advantage of the sintering apparatuses of the present invention is that heating at high heating rates of at least 50 °C/s can be obtained. Further advantages of the sintering apparatuses of the present invention are, without being limited thereto, that a wide variety of substrates can be sintered in short times and in a uniform way.

Further, the sintering apparatuses of the present invention are in particular suited for sintering thin and/or substantially flat substrates, as well as self-standing substrates. This is realized by the combination of the third and fourth thermally conductive substrates comprising one or more of a metal nitride and/or a metal oxide and which are heated, and the first and second thermally conductive substrates comprising carbon placed between the substrate (i.e. article or object) to be sintered and the third and fourth thermally conductive substrates.

### DESCRIPTION OF THE FIGURES

Aspects of the invention will now be described in more detail with reference to the appended drawings, wherein same reference numerals illustrate same features and wherein:

FIGS. 1 to 11 schematically represent various sintering apparatuses according to the invention;

FIGS. 12A and 12B show SEM-images at different resolution of the cross-section of an inorganic substrate sintered by means of an apparatus of the prior art;

FIGS. 13A and 13B show SEM-images at different resolution of the cross-section of an inorganic substrate sintered by means of a sintering apparatus of the present invention.

### DETAILED DESCRIPTION OF THE INVENTION

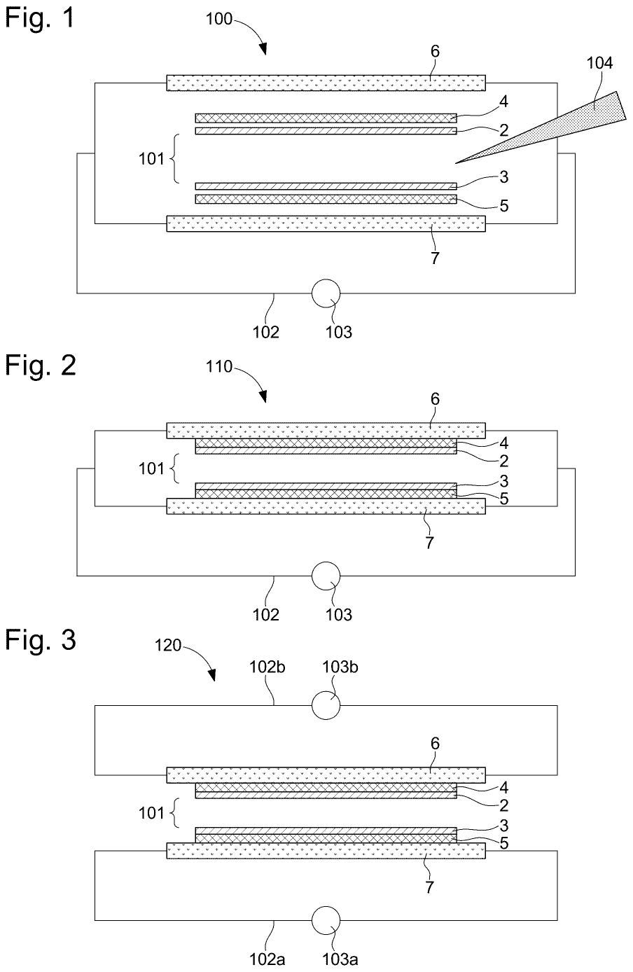

FIG. 1 schematically shows a sintering apparatus 100 according to a first embodiment of the present disclosure. The sintering apparatus 100 has a substantially horizontal arrangement. The apparatus 100 comprises a first thermally conductive substrate 2 and a second thermally conductive substrate 3, provided at a distance from each other so that a space 101 is provided. In use of the apparatus, an object to be sintered, for example an inorganic substrate, is advantageously placed within the space 101, i.e. between the first 2 and the second 3 thermally conductive substrates.

The first 2 and the second 3 thermally conductive substrates are provided in between a third thermally conductive substrate 4 and a fourth thermally conductive substrate 5. In other words, the third 4 and fourth 5 thermally conductive substrates surround or enclose the first 2 and the second 3 thermally conductive substrates.

Advantageously, the first 2 and the second 3 thermally conductive substrates, independently from each other, comprise or substantially consist of carbon. Examples of carbon-comprising thermally conductive substrates include, without being limited thereto, graphite, carbon fibres, carbon nanotubes, or combinations of two or more thereof. The first 2 and the second 3 thermally conductive substrate can have the same or a different composition. The first 2 and the second 3 thermally conductive substrate can be, independently from one another, substantially flat. Alternatively, and independently from one another, they can have a geometry following the geometry of the object to be sintered. Advantageously, the first 2 and the second 3 thermally conductive substrate have, independently from one another, a thickness between 0.5 μm and 20 mm, preferably between 1 μm and 10 mm.

The third 4 and the fourth 5 thermally conductive substrate can have the same or a different composition. Advantageously, the third 4 and the fourth 5 thermally conductive substrate comprise or substantially consist of metal nitrides or metal oxides. Non-limiting examples of metal nitrides include boron nitride or aluminium nitride. Non-limiting examples of metal oxides include aluminium oxide or sapphire, such as sapphire single crystals. Advantageously, the metal nitrides comprise or substantially consist of monocrystalline metal nitrides. Advantageously, the metal oxides comprise or substantially consist of monocrystalline metal oxides. The inventors have discovered that monocrystalline metal nitrides and monocrystalline metal oxides are capable to resist better, i.e. do not show significant damage or deterioration, the high heating rates (i.e. at least 50 °C/s) and the high cooling rates (i.e. at least −50 °C /s) that can be realised by the sintering apparatus of the present disclosure, when compared to the non-monocrystalline metal nitrides and metal oxides.

Advantageously, at least a portion of, and preferably the entire, surface or surfaces of the third 4 and/or the fourth 5 thermally conductive substrate is polished.

The third 4 and the fourth 5 thermally conductive substrate can be, independently from one another, substantially flat. Alternatively, and independently from one another, they can have a geometry following, i.e. matching, the geometry of the object to be sintered. Advantageously, the third 4 and the fourth 5 thermally conductive substrate have, independently from one another, a thickness between 0.5 μm and 20 mm, preferably between 1 μm and 10 mm.

The inventors have surprisingly discovered that by using a third 4 and a fourth 5 thermally conductive substrate as explained hereinabove, it is possible to sinter substrates while maintaining their original shape or geometry. In particular, the sintering apparatuses of the present invention allow to sinter flat substrates, even when they are thin (i.e. having a thickness of 100 μm or less), thereby maintaining their flatness upon sintering. In other words, upon sintering flat substrates with the sintering apparatuses of the present disclosure, the curving of the substrate is prevented.

Further, sufficient support is provided to the substrates to be sintered, excluding the need for supporting means, such as a tray, for the object during sintering. Consequently, the sintering apparatuses of the present invention allow the sintering of self-standing substrates, such as self-standing, thin, membranes.

The inventors have surprisingly discovered that by using a first 2 and a second 3 thermally conductive substrate comprising carbon and provided, in use of the apparatus, between the substrate to be sintered and the third 4 and the fourth 5 thermally conductive substrate, any solid state reaction that might take place between the object to be sintered and the third 4 and the fourth 5 thermally conductive substrate can be avoided. Such solid state reactions typically influence negatively the sintering quality, and are thus unwanted reactions. Consequently, the sintering apparatuses according to the present invention allow to avoid any such reactions, thereby improving the sintering quality.

The sintering apparatus 100 of FIG. 1 further comprises a first conductor 6 and a second conductor 7. Advantageously, the first 6 and the second 7 conductor have a surface area that is equal to or larger than the surface area of the third 4 and fourth 5 thermally conductive substrate, respectively.

Advantageously, the first conductor 6 and the second conductor 7, individually, comprise or substantially consist of carbon. Examples of carbon-comprising conductors include, without being limited thereto, graphite, carbon fibres, carbon nanotubes, or combinations of two or more thereof. Advantageously, the first 6 and the second 7 conductor comprise or substantially consist of a carbon nonwoven material, such as a carbon felt.

The sintering apparatus 100 further comprises heating means 102. The heating means are connected to the first conductor 6 and to the second conductor 7. The connection can be any electrical connection known in the art and will, in use, transfer the electrical current from the heating means 102 to the first 6 and the second 7 conductor, i.e. induce the electrical current to the conductors 6, 7. A power source 103 is provided to generate the electrical current. The power source 103 can be a direct current (DC) power source or an alternating current (AC) power source.

In use, when a substrate to be sintered in provided within the space 101 of the sintering apparatus 100, the power source 103 will generate an electrical current, which is induced by means of the heating means 102 to the first 6 and the second 7 conductor. The electrical current will flow through the conductors 6, 7, and any loses due to the resistance of the material of the conductors 6, 7, is transferred in heat. This heat results in a heating of the third 4 and the fourth 5 thermally conductive substrates, which results in turn in the heating of the first 2 and the second 3 thermally conductive substrates, and so into heating of the substrate to be sintered.

The sintering apparatus allows for obtaining a heating rate of 50 °C/s or more, such as at least 60 °C/s, or even 70 °C/s or more, i.e. the sintering apparatus is an ultrafast sintering apparatus.

Advantageously, the sintering apparatus allows for obtaining a cooling rate of 50 °C/s or more, i.e. cooling an article or object to a temperature which is at least 50 °C lower than the temperature of the article or object the second before, such as at least 60 °C/s, or even 70 °C/s or more.

Advantageously, the sintering apparatus 100 further comprises a means for monitoring the temperature 104 within the sintering apparatus 100. Advantageously, the means for monitoring the temperature 104 comprises an IR sensor and/or an IR camera. Advantageously, the means for monitoring the temperature 104 allow for measuring the temperature and controlling the temperature, so that the temperature remains at a predefined value or within a predefined range.

The means for monitoring the temperature 104 can be arranged so that it monitors the temperature within the space 101, i.e. of the object to be sintered during sintering. Alternatively or additionally, the means 104 can be arranged to monitor the temperature of one or more of the first 2, the second 3, the third 4 or the fourth 5 thermally conductive substrate.

Advantageously, the sintering apparatus further comprises cooling means (not shown). Advantageously, the cooling means allow for cooling the space, i.e. the sintered object, at a cooling rate of at least −50 °C/s.

Advantageously, the sintering apparatus is arranged in a glovebox (not shown) that is, during use, filled with an inert gas. In other words, the sintering apparatus is advantageously arranged for carrying out a sintering process in an inert atmosphere, such as an atmosphere comprising argon, nitrogen or helium.

The third thermally conductive substrate 4 can be provided at a distance from the first thermally conductive substrate 2 and/or at a distance from the first conductor 6. Advantageously, each distance individually is between 0.05 mm and 25 mm, such as between 0.1 mm and 20 mm, between 0.2 mm and 15 mm, or between 0.25 mm and 10 mm. Alternatively, the third thermally conductive substrate 4 can be at least partially in contact, e.g. can be at least partially touching, the first thermally conductive substrate 2 and/or can be at least partially in contact with the first conductor 6.

The fourth thermally conductive substrate 5 can be provided at a distance from the second thermally conductive substrate 3 and/or at a distance from the second conductor 7. Advantageously, each distance individually is between 0.05 mm and 25 mm, such as between 0.1 mm and 20 mm, between 0.2 mm and 15 mm, or between 0.25 mm and 10 mm. Alternatively, the fourth thermally conductive substrate 5 can be at least partially in contact, e.g. can be at least partially touching, the second thermally conductive substrate 3 and/or can be at least partially in contact with the second conductor 7.

FIG. 2 shows a sintering apparatus 110. Contrary to the sintering apparatus 100 of FIG. 1, the third thermally conductive substrate 4 contacts the first thermally conductive substrate 2 and the first conductor 6 over its entire surface area. In other words, the third thermally conductive substrate 4 is sandwiched between the first thermally conductive substrate 2 and the first conductor 6. Further, the fourth thermally conductive substrate 5 contacts the second thermally conductive substrate 3 and the second conductor 7 over its entire surface area as well.

Optionally, the first conductor 6 at least partially encloses the third thermally conductive substrate 4 (not shown). Additionally, and still optionally, the first conductor 6 can also at least partially enclose the first thermally conductive substrate 2, the space 101, and even the second 3 and the fourth 5 thermally conductive substrate. Similarly and optionally, the second conductor 7 at least partially encloses the fourth thermally conductive substrate 5 (not shown). Additionally, and still optionally, the second conductor 7 can also at least partially enclose the second thermally conductive substrate 3, the space 101, and even the first 2 and the third 4 thermally conductive substrate.

In other words, the first conductor 6 and/or the second conductor 7 can be a covering, for example a wrapping or an envelope, thereby enclosing the space 101 and the thermally conductive substrates 2, 3, 4, 5, thereby still providing an opening so that a substrate to be sintered can be provided within the space.

The advantage of the first 6 and/or the second 7 conductor at least partially enclosing one or more of the thermally conductive substrates 2, 3, 4, 5, and optionally the space 101 is that a more uniform and/or a higher heating rate can be obtained.

FIG. 3 shows a sintering apparatus 120 according to a further embodiment of the present invention. The sintering apparatus 120 comprises a first 2, second 3, third 4, and fourth 5 thermally conductive substrate, and a first 6 and a second 7 conductor as disclosed in FIG. 2, providing a space 101 between the first 2 and the second 3 thermally conductive substrate.

The sintering apparatus 120 further comprises first heating means 102a connected to the second conductor 7 and to a first power source 103a. The sintering apparatus 120 further comprises second heating means 102b connected to the first conductor 6 and to a second power source 103b. The power sources 103a, 103b can be as described hereinabove.

The first heating means 102a are arranged to, in use, induce an electrical current to the second conductor 7. The second heating means 102b are arranged to, in use, induce an electrical current to the first conductor 6. Upon induction of an electrical current to the conductor 6, 7, the adjacent thermally conductive substrate 5, 4 is heated. Consequently, the thermally conductive substrate 3, 2 adjacent to the heated thermally conductive substrate 5, 4 is also heated, resulting in heating and sintering of the object to be sintered.

The provision of separate heating means 102a, 102b, each connected to a different conductor 7, 6 has the advantage that a different amount or level of electrical current can be induced to the respective conductor. In other words, the first 102a and the second 102b heating means are arranged so that advantageously the fourth 5 and the second 3, and the third 4 and the first 2 thermally conductive substrates, respectively, can be heated to a different temperature, at a different heating rate, and/or for a different duration (i.e. a different sintering time). This allows to obtain a sintered substrate having, for example, a first porosity at a first surface and a second porosity different from the first porosity at a second surface, such as the surface opposite to the first surface. For example, a substrate having a porosity gradient throughout its thickness can be obtained. This is realised since different sintering temperatures and/or different sintering durations tend to lead to a different, i.e. a lower or higher, degree of porosity obtained. For example, a bilayer dense-porous substrate can be obtained from a single substrate in this way.

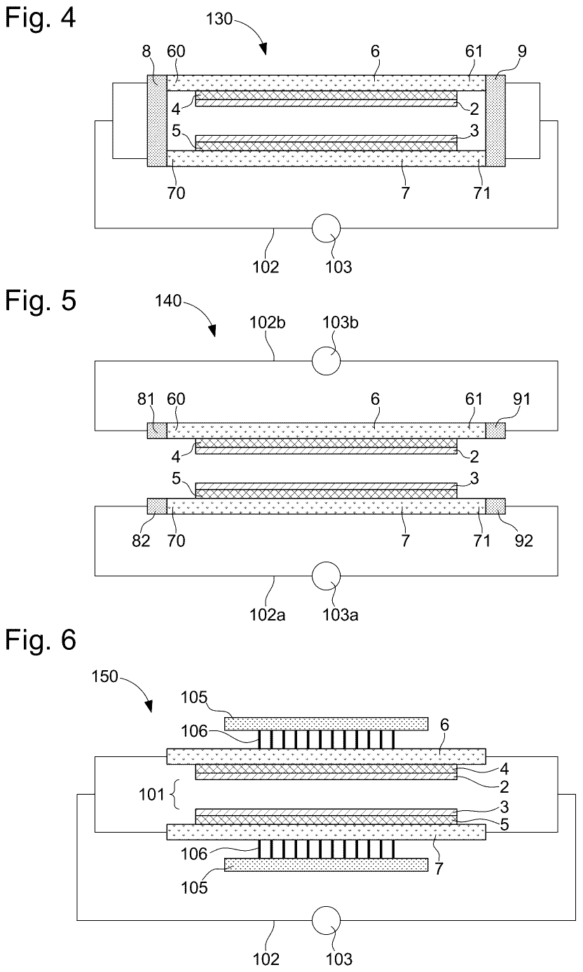

FIG. 4 discloses a further embodiment of a sintering apparatus 130 of the invention. The sintering apparatus 130 comprises a first 2, second 3, third 4, and fourth 5 thermally conductive substrate, and a first 6 and a second 7 conductor as disclosed in FIG. 2.

The sintering apparatus 130 further comprises a third conductor 8 and a fourth conductor 9. Advantageously, the third 8 and the fourth 9 conductor have an electrical conductivity between 10⁻³ S/cm and 75*10⁴ S/cm. Advantageously, the third 8 and the fourth 9 conductor comprise, independently from one another, copper, a copper alloy, silver, a silver alloy, tungsten, a tungsten alloy, iron, an iron alloy, or a combination of two or more thereof.

Advantageously, the third conductor 8 is provided at a proximal end 60 of the first conductor 6 and at a proximal end 70 of the second conductor. Advantageously, the third conductor 8 contacts at least partially, and preferably entirely, the first conductor 6 at its proximal end 60 and/or contacts at least partially, and preferably entirely, the second conductor 7 at its proximal end 70.

Advantageously, the fourth conductor 9 is provided at a distal end 61 of the first conductor 6 and at a distal end 71 of the second conductor. Advantageously, the fourth conductor 9 contacts at least partially, and preferably entirely, the first conductor 6 at its distal end 61 and/or contacts at least partially, and preferably entirely, the second conductor 7 at its distal end 71.

Advantageously, the heating means 102 are connected to the third 8 and the fourth 9 conductor and to a power source 103. By this, in use, an electrical current can be induced to the third 8 and the fourth 9 conductor, and thereby to the first 6 and the second 7 conductor, so as to heat the substrate to be sintered as described hereinabove.

FIG. 5 discloses a yet another embodiment of a sintering apparatus 140 of the invention. The sintering apparatus 140 comprises a first 2, second 3, third 4, and fourth 5 thermally conductive substrate, and a first 6 and a second 7 conductor as disclosed in FIG. 2.

The sintering apparatus 140 further comprises a third conductor comprising a first portion 81 and a second portion 82. The sintering apparatus 140 further comprises a fourth conductor comprising a first portion 91 and a second portion 92. Advantageously, the third and the fourth conductor have an electrical conductivity between 10⁻³ S/cm and 75*10⁴ S/cm. Advantageously, the third and the fourth conductor comprise, independently from one another, copper, a copper alloy, silver, a silver alloy, tungsten, a tungsten alloy, iron, an iron alloy, or a combination of two or more thereof.

Advantageously, the first portion 81 of the third conductor is provided at, and in particular contacts at least partially, a proximal end 60 of the first conductor 6. Advantageously, the first portion 91 of the fourth conductor is provided at, and in particular contacts at least partially, a distal end 61 of the first conductor 6. Second heating means 102b are connected to the first portions 81, 91 and to a second power source 103b. The second heating means 102b are arranged to induce, in use, a current to the first portions 81, 91 and in this way to the first conductor 6. This results in Joule heating of the third 4 and the first 2 thermally conductive substrate, as explained hereinabove.

Advantageously, the second portion 82 of the third conductor is provided at, and in particular contacts at least partially, a proximal end 70 of the second conductor 7. Advantageously, the second portion 92 of the fourth conductor is provided at, and in particular contacts at least partially, a distal end 71 of the second conductor 7. First heating means 102a are connected to the second portions 82, 92 and to a first power source 103a. The first heating means 102a are arranged to induce, in use, a current to the second portions 82, 92 and in this way to the second conductor 7. This results in Joule heating of the fourth 5 and the second 3 thermally conductive substrate, as explained hereinabove.

FIG. 6 discloses a sintering apparatus 150 according to a further embodiment of the present disclosure. The sintering apparatus 150 a first 2, second 3, third 4, and fourth 5 thermally conductive substrate, a first 6 and a second 7 conductor, heating means 102 and a power source 103 as disclosed in FIG. 2.

The sintering apparatus 150 further comprises first supporting means and second supporting means. Advantageously, the first supporting means is provided at an outer surface of the first conductor 6, i.e. at the side of the first conductor 6 opposite to the side facing, i.e. oriented towards (or, in the case of FIG. 6, contacting), the third thermally conductive substrate 4. Advantageously, the second supporting means is provided at an outer surface of the second conductor 7.

Advantageously, each supporting means comprises a ceramic substrate 105. Advantageously, the ceramic substrate 105 is thermally and/or electronically insulating, preferably thermally and electronically insulating. Advantageously, the ceramic substrate 105 comprises or substantially consists of aluminium oxide.

Advantageously, each supporting means further comprises at least one metallic supporting component 106, preferably at least 2, more preferably at least 3, i.e. a plurality of metallic supporting components 106. Advantageously, the metallic supporting component 106 comprises or substantially consists of one or more metals and/or alloys thereof, which are capable to withstand the sintering temperatures. In particular, the metallic supporting component 106 comprises or substantially consists of one or more metals and/or alloys thereof having a melting temperature of at least 1500 °C, for example at least 1750 °C or at least 2000 °C, so as to avoid melting of the metallic supporting component 106 during heating and sintering.

Advantageously, the metallic supporting component 106 comprises or substantially consists of tungsten or an alloy thereof. Non-limiting examples of tungsten comprising alloys are tungsten nickel iron alloys, tungsten nickel copper alloys and tungsten carbide alloys.

The metallic supporting component 106 can have any shape which allows to arrange the metallic supporting component 106 between the ceramic substrate 105 and the (first or second) conductor 6, 7, so that the metallic supporting component 106 contacts both the ceramic substrate 105 and the conductor 6, 7. Non-limiting examples of shapes include cylinders, cubes, pyramidal shapes and spheres. Non-limiting practical examples of structures include pins, rods, and cylinders.

Advantageously, the metallic supporting component 106 is attached to the ceramic substrate 105. The attachment can be any type of attachment known in the field. Advantageously, the metallic supporting component 106 is embedded into the ceramic substrate 105.

Upon contacting, the supporting means provide mechanical support to the conductor, and consequently also to the thermally conductive substrates. The supporting means mechanically support in this way, in use of the sintering apparatus 150, the substrate to be sintered. This excludes the need for providing the substrate to be sintered within the space 101 together with a carrier or a supporting structure. In other words, the sintering apparatus 150, comprising supporting means, allows for the sintering of self-standing substrates.

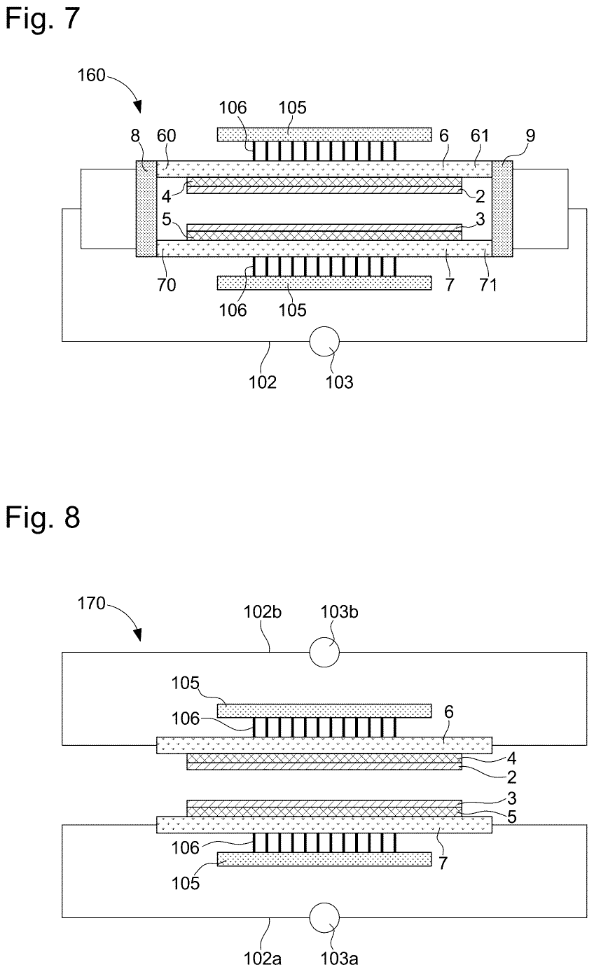

FIG. 7 discloses a sintering apparatus 160 according to a further embodiment of the present disclosure. The sintering apparatus 160 a first 2, second 3, third 4, and fourth 5 thermally conductive substrate, and a first 6, second 7, third 8 and fourth 9 conductor as disclosed in FIG. 4. The sintering apparatus 160 further comprises first and second supporting means as disclosed in FIG. 6.

FIG. 8 discloses a sintering apparatus 170 according to a further embodiment of the present disclosure. The sintering apparatus 170 comprises a first 2, second 3, third 4, and fourth 5 thermally conductive substrate, a first 6 and a second 7 conductor, first 102a and second 102b heating means and a first 103a and a second 103b power source as disclosed in FIG. 3. The sintering apparatus 170 further comprises first and second supporting means as disclosed in FIG. 6.

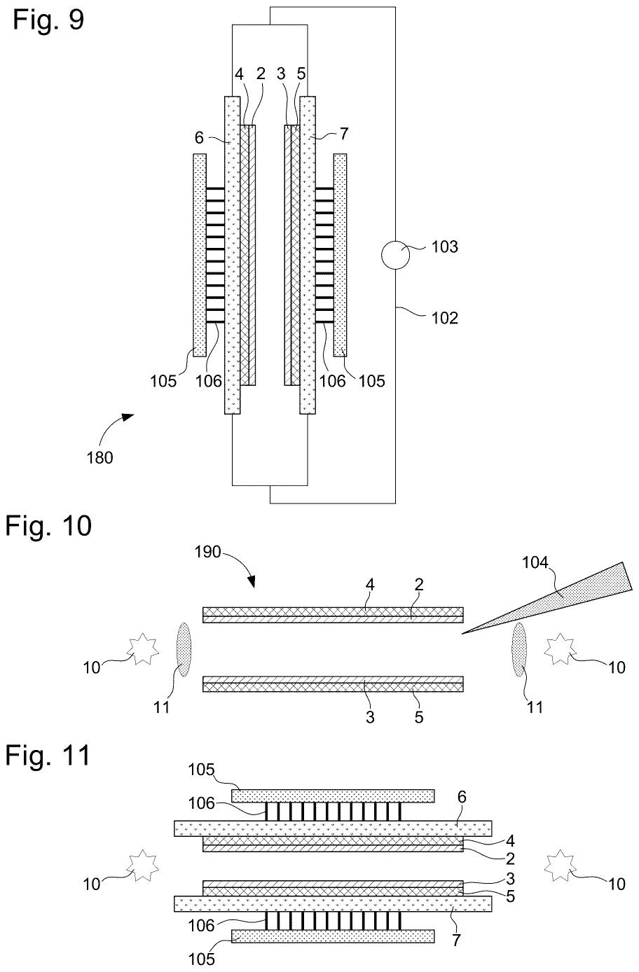

The sintering apparatuses of the present invention can be provided in a substantially horizontal configuration, i.e. at an angle of 90° to the earth's gravitational field (shown in FIGS. 1 to 8). The sintering apparatuses can also be provided in a substantially vertical position, i.e. at an angle of 0° to the earth's gravitational field, as shown in FIG. 9. The sintering apparatuses can also be provided in any position between a substantially horizontal position (i.e. angle 90°) and a substantially vertical position (i.e. angle 0°).

FIG. 9 shows a sintering apparatus 180 similar to the sintering apparatus 150 of FIG. 6, but arranged in a vertical position (angle 0° to the earth's gravitational field). The inventors have discovered that a vertical position allows during sintering easier movement of the particles within the object or substrate to be sintered because of the gravitation. Such a vertical set-up is in particular advantageous for sintering flat substrates, such as films, foils and membranes.

FIG. 10 shows a sintering apparatus 190 according to a yet another embodiment. The sintering apparatus 190 comprises a first 2 thermally conductive substrate contacting a third 4 thermally conductive substrate, and a second 3 thermally conductive substrate contacting a fourth 5 thermally conductive substrate. The thermally conductive substrates 2, 3, 4, 5 are advantageously as described hereinbefore. The sintering apparatus 190 further comprises means for monitoring the temperature 104, which is advantageously as described hereinabove.

The sintering apparatus 190 further comprises heating means 10, which comprises a light source. Advantageously, the light source is an infrared (IR) light source. The IR light source advantageously comprises one or a plurality of IR heaters. Particularly suited IR heaters are short wave IR heaters and ceramic IR heaters. Advantageously, the IR heaters operate at 6 kW or less. Advantageously, the IR light source is operated at a temperature between 500 °C and 1300 °C, preferably between 600 °C and 1000 °C, most preferably between 650 °C and 800 °C, such as between 700 °C and 750 °C. Advantageously, the IR light source is turned on, i.e. the IR light source heats the thermally conductive substrates 2, 3, 4, 5 and/or the space between the first 2 and the second 3 thermally conductive substrate for a duration between 5 seconds and 40 minutes, preferably between 10 seconds and 30 minutes, for example between 1 minute and 25 minutes, between 2 minutes and 20 minutes, between 5 minutes and 15 minutes, more preferably between 7 minutes and 10 minutes, such as between 9 minutes and 10 minutes. It will be understood that the optimal duration depends on the IR light source, in particular of its power.

The sintering apparatus 190 further comprises a lens 11 arranged between the light source 10 and the thermally conductive substrates 2, 3, 4, 5. Advantageously, the lens 11 is arranged to focus, in use, the light beam emitted from the light source, in particular an IR light beam, towards the thermally conductive substrates 2, 3, 4, 5 and/or towards the space between the first 2 and the second 3 thermally conductive substrate. This allows to reduce the energy (heat) loses and provides for a more efficient sintering apparatus.

FIG. 11 shows a sintering apparatus 200 according to a further embodiment. The sintering apparatus 200 comprises a first 2 thermally conductive substrate contacting a third 4 thermally conductive substrate, and a second 3 thermally conductive substrate contacting a fourth 5 thermally conductive substrate. The thermally conductive substrates 2, 3, 4, 5 are advantageously as described hereinbefore. The sintering apparatus 200 further comprises a first 6 and a second 7 conductor, which are advantageously as described hereinbefore, and which contact the third 4 and the fourth 5 thermally conductive substrate, respectively.

The sintering apparatus 200 further comprises first and second supporting means comprising a ceramic substrate 105 and at least one metallic supporting component 106. The first and the second supporting means are advantageously as described hereinbefore.

The sintering apparatus 200 further comprises an IR light source 10. The IR light source 10 is arranged so that, in use, the IR light emitted heats the conductors 6, 7 and the thermally conductive substrates 2, 3, 4, 5, and so the substrate to be sintered as well.

### EXAMPLES

### Example 1

A reference porous substrate and an inventive porous substrate were made from a green structure having the same composition, wherein the reference porous substrate is obtained by sintering by means of a prior art sintering apparatus, and the inventive porous substrate is obtained by sintering by means of a sintering apparatus according to the present invention.

First, a mixture was prepared by mixing 3 g Li_{6.25}Al_{0.25}La₃Zr₂O₁₂ (aluminium-doped LLZO, or Al-LLZO), 0.075 gLi₂CO₃ (2.5 wt%), 0.56 mL plasticizer, 0.59 g surfactant and 2.07 g poly(methyl methacrylate) (PMMA) as pore-forming compound and 5.9 mL solvent comprising 5 vol. % isopropanol, 87 vol. % ethanol and 8 vol. % 1-propanol with a spatula, followed by ball milling for 18 hours at 165 rpm. A binder solution was prepared by adding 3 g polyvinyl butyral to 8.89 mL isopropanol. 2.51 g of the binder solution was added to the mixture (a suspension), followed by further ball milling for 2 hours at 200 rpm.

The mixture was film-casted by tape-casting on a glass substrate. This was performed twice, to obtain two green structures (i.e. one for each sintering method). The obtained green structures were kept for 1 hour at ambient conditions to allow evaporation of the solvent, and were then removed from the glass substrate.

The green structures were then placed between two alumina plates. Debinding of the green structures was performed at 600 °C in air to completely remove the solvents (evaporation temperatures of at most 150 °C), the PMMA (at around 350 °C) and residual organic compounds, such as the binders and plasticizers (at approx. 600 °C).

A reference (sintered) LLZO substrate was obtained by placing a first green structure between two carbon foils, which were then sandwiched between two carbon plates. Sintering was performed in a nitrogen atmosphere at 1250 °C for 30 seconds.

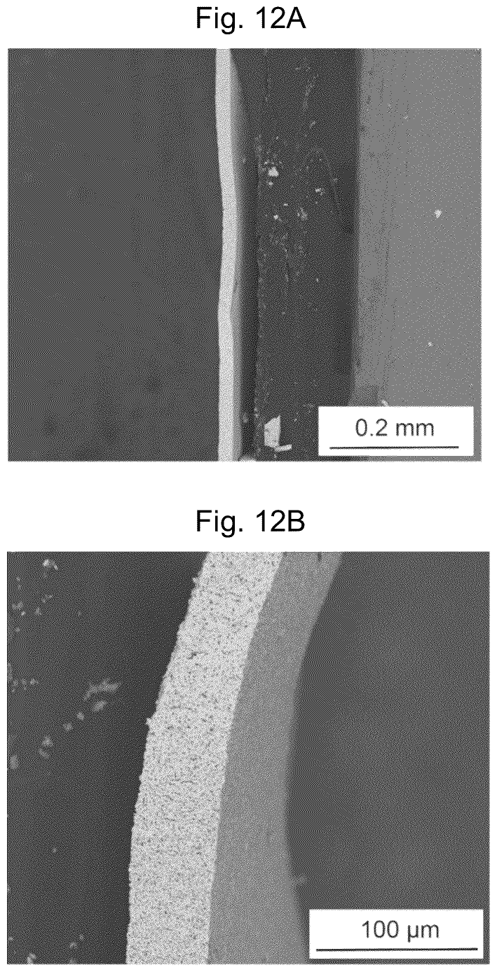

SEM-images of the cross-section (FIGS. 12A and 12B, at different magnifications) of the obtained reference sintered LLZO substrate clearly show that the hereby obtained reference sintered LLZO substrate was not flat, but highly curved. Also some cracks were noticed. The SEM-images were recorded using a Hitachi ™3030Plus Tabletop microscope with an acceleration voltage of 10 kV.

Similar results were also obtained by sintering in the same set-up, in a nitrogen atmosphere at temperatures between 1000 °C and 1250 °C for a duration between 30 seconds and 120 seconds.

An inventive (sintered) LLZO substrate was obtained by placing a second green structure, having the same composition as the first green structure, in an apparatus 160 according to FIG. 7.

The first 2 and the second 3 thermally conductive substrate substantially consisted of carbon foils. The third 4 and the fourth 5 thermally conductive substrates were boron nitride plates. The boron nitride plates were rigid and substantially flat. The first 6 and the second 7 conductor substantially consisted of carbon, and were carbon felts. At the outside, supporting means were provided, comprising an alumina substrate 105 and a plurality of tungsten pins as metallic supporting component 106. A copper third conductor 8 was provided at a proximal end of the first 6 and the second 7 conductor, and a copper fourth conductor 9 was provided at a distal end of the first 6 and the second 7 conductor. The third 8 and the 9 conductor were connected by means of electronic circuitry 102 as heating means to a power source 103.

After placing the second green structure between the carbon foils 2, 3, the power source 103 was turned on and an electrical current was induced to, and ran through the carbon felts. Resistive losses of the current resulted in heating of the boron nitride plates, which in turn heated the carbon foils, and the green structure at a heating rate of about 60 °C/s to a temperature of 1250 °C. Once the temperature of 1250 °C was reached, it was maintained for 30 seconds by continued current passing through the carbon felts.

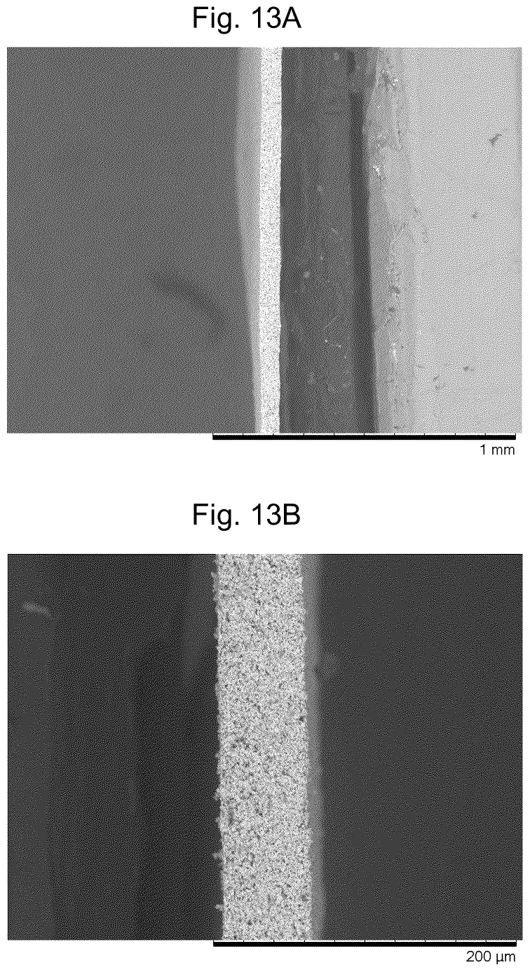

SEM-images of the cross-section (FIGS. 13A and 13B, at different magnifications) of the obtained inventive sintered LLZO substrate clearly show that the inventive sintered LLZO substrate was substantially flat. Similar results were also obtained by sintering in the same apparatus and set-up at temperatures between 1000 °C and 1250 °C for a duration between 30 seconds and 120 seconds.

### Example 2

A further green structure according to Example 1 was sintered in an apparatus 190 according to FIG. 10. The first 2 and the second 3 thermally conductive substrate substantially consisted of carbon foils. The third 4 and the fourth 5 thermally conductive substrates were boron nitride plates. The boron nitride plates were rigid and substantially flat.

The green structure was placed between carbon foils 2,3. An IR light source comprising an IR heater operating at 6 KW was used as heating means. The IR irradiation heated the boron nitride plates 4,5 via thermal radiation, and the heat was transferred to the carbon foils 2,3 and to the green structure. The boron nitride plates 4,5 were heated to a temperature of 700 °C for a duration of 550 seconds. Afterwards, the IR light source was turned off and the boron nitride plates, the carbon foils and the sintered LLZO substrate were allowed to cool to room temperature.

The obtained sintered LLZO substrate was visually inspected, and was found to be substantially flat.

### NOMENCLATURE

2. first thermally conductive substrate
3. second thermally conductive substrate
4. third thermally conductive substrate
5. fourth thermally conductive substrate
6. first conductor
7. second conductor
8. third conductor
9. fourth conductor
10. infrared (IR) light source
11. lens
60. proximal end of first conductor
61. distal end of first conductor
70. proximal end of second conductor
71. distal end of second conductor
81. (first portion of) third conductor
82. (second portion) of third conductor
91. (first portion of) fourth conductor
92. (second portion of) fourth conductor
100. apparatus for sintering
101. space between first and second thermally conductive substrates
102. means for inducing electrical current
102a. means for inducing electrical current
102b. means for inducing electrical current
103. power source
103a. power source
103b. power source
104. means for monitoring temperature
105. thermally and electronically insulating ceramic substrate
106. metallic supporting component
110. sintering apparatus
120. sintering apparatus
130. sintering apparatus
140. sintering apparatus
150. sintering apparatus
160. sintering apparatus
170. sintering apparatus
180. sintering apparatus
190. sintering apparatus
200. sintering apparatus

1-16. (canceled)

17. Ultrafast high-temperature sintering apparatus comprising:
a first thermally conductive substrate (2) and a second thermally conductive substrate (3) arranged at a distance from each other, thereby providing a space (101) for receiving a substrate to be sintered, and provided between
a third thermally conductive substrate (4) and a fourth thermally conductive substrate (5), and
heating means (10, 102, 102a, 102b) for heating the third thermally conductive substrate (4) and/or the fourth thermally conductive substrate (5), thereby heating the first (2) and/or the second (3) thermally conductive substrate, respectively,
wherein the first (2) and the second (3) thermally conductive substrate comprises carbon, and
wherein the third thermally conductive substrate (4) and the fourth thermally conductive substrate (5) comprise, independently from one another, one or more metal nitride and/or metal oxide.

18. The sintering apparatus according to claim 17, wherein the third (4) and the fourth (5) thermally conductive substrates comprise, independently from one another, one or more monocrystalline metal nitride and/or monocrystalline metal oxide.

19. The sintering apparatus according to claim 17, wherein the metal nitride comprises boron nitride and/or aluminium nitride.

20. The sintering apparatus according to claim 17, wherein the metal oxide comprises alumina and/or sapphire.

21. The sintering apparatus according to claim 17, wherein the first (2) thermally conductive substrate contacts at least partially the third (4) thermally conductive substrate, and/or the second (3) thermally conductive substrate contacts at least partially the fourth (5) thermally conductive substrate.

22. The sintering apparatus according to claim 17, further comprising a first conductor (6) at an outer surface of the third thermally conductive substrate (4) and/or a second conductor (7) at an outer surface of the fourth thermally conductive substrate (5), preferably wherein the first (6) and the second (7) conductor comprises carbon.

23. The sintering apparatus according to claim 22, wherein the first conductor (6) and the second conductor (7) together at least partially, and preferably entirely, enclose the first (2) the second (3), the third (4) and the fourth (5) thermally conductive substrate, and the space (101).

24. The sintering apparatus according to claim 22, further comprising a first supporting means provided at an outer surface of the first conductor (6) and/or a second supporting means provided at an outer surface of the second conductor (7), wherein each one of the first supporting means and the second supporting means independently comprises a thermally and electronically insulating ceramic substrate (105) and at least one metallic supporting component (106), wherein the supporting means is arranged so that the metallic supporting component (106) contacts the thermally and electronically insulating ceramic substrate (105) and the conductor (6, 7).

25. The sintering apparatus according to claim 24, wherein the thermally and electronically insulating ceramic substrate (105) comprises alumina.

26. The sintering apparatus according to claim 24, wherein the metallic supporting component (106) comprises tungsten or an alloy thereof.

27. The sintering apparatus according to claim 22, wherein the heating means (102, 102a, 102b) comprise means for inducing an electrical current to the first (6) and/or the second conductor (7), thereby, in use, heating the third (4) and/or the fourth (5) thermally conductive substrate.

28. The sintering apparatus according to claim 22, further comprising a third conductor (8, 81, 82) at a proximal end (60) of the first conductor (6) and/or at a proximal end (70) of the second conductor (7), and a fourth conductor (9, 91, 92) at a distal end (61) of the first conductor (6) and/or at a distal end (71) of the second conductor (7), wherein the heating means (102, 102a, 102b) comprise means for inducing an electrical current to the third (8, 81, 82) and the fourth conductor (9, 91, 92), thereby, in use, inducing the electrical current to the first (6) and/or the second (7) conductor and the heating the third (4) and/or the fourth (5) thermally conductive substrate, respectively, preferably wherein the third (8, 81, 82) and the fourth (9, 91, 92) conductor comprises copper, tungsten, of a combination thereof.

29. The sintering apparatus according to claim 17, wherein the heating means (10) comprises an infrared (IR) light source.

30. The sintering apparatus according to claim 29, further comprising one or more lenses (11).

31. The sintering apparatus according to claim 17, wherein the heating means (10, 102a, 102b) are arranged to allow, in use, heating the third and the fourth (5) thermally conductive substrate independently of one another.

32. The sintering apparatus according to claim 17, further comprising means for monitoring the temperature (104) of the space (101) between the first (2) and the second (3) thermally conductive substrate, preferably wherein the means for monitoring the temperature (104) comprise an infrared (IR) camera.
